(19) United States
(12) Patent Application Publication
(10) Pub. No.: US 2007/0116934 A1
(43) Pub. Date: May 24, 2007

(54) Antireflective surfaces, methods of manufacture thereof and articles comprising the same

(76) Inventor: Scott Michael Miller, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/285,628

(22) Filed: Nov. 22, 2005

(51) Int. Cl. B32B 3/00

(52) U.S. Cl. 428/172

(57) ABSTRACT

Disclosed herein is an antireflective viewing surface comprising a viewing surface; and a textured layer disposed upon the viewing surface; wherein the textured layer comprises a plurality of protrusions that are smaller than the wavelength of light and that are aperiodically distributed across the viewing surface. Disclosed herein too is a method of manufacturing an antireflective viewing surface comprising electroforming a metal upon a first template to form an electroformed metal template; wherein the first template comprises a plurality of pores; disposing a layer of a polymeric resin on a viewing surface; pressing the electroformed metal template against the polymeric resin; and solidifying the polymeric resin.

### BACKGROUND

This disclosure relates to antireflective surfaces, methods of manufacture thereof and articles comprising the same.

Antireflective surfaces are desired for a large number of commercial applications, including display screens, optical components such as lenses, eyeglasses, face shields, windshields, and greenhouse roofs. For these applications, the purpose of the antireflective surface is variously to increase total transmitted light or to reduce specular reflection.

Light is reflected from a surface because of the abrupt change in the index of refraction of the medium through which the light is traveling. Commercial antireflective surfaces consist of one or more thin coatings of varying indices of refraction designed to produce destructive optical interference of the reflected light. These antireflective surfaces are produced by applying layers of different coatings to a surface; the thickness and index of refraction of each layer is chosen to minimize reflected light over a broad range of light wavelengths. Such coatings are prepared by either vacuum deposition or wet coating. Vacuum-deposited coatings produce suitable performance but are expensive to produce. Wet-coated antireflective coatings do not perform as well as the vacuum-deposited films but are less expensive to produce.

The corneal lenses of moths and some other nocturnal insects exhibit antireflective properties because they are covered with nanoscale protrusions. These surfaces, which are referred to as nanotextured surfaces, function by employing features smaller than the wavelength of the incident light to create an effective gradient in the index of refraction rather than a sharp transition at the surface.

It is therefore desirable to produce antireflective surfaces comprising this “moth-eye” principle to provide effective antireflective surfaces that can be inexpensively manufactured on a large scale.

### SUMMARY

Disclosed herein is an antireflective viewing surface comprising a viewing surface; and a textured layer disposed upon the viewing surface; wherein the textured layer comprises a plurality of protrusions that are smaller than the wavelength of light and that are aperiodically distributed across the viewing surface.

Disclosed herein too is a method of manufacturing an antireflective viewing surface comprising electroforming a metal upon a first template to form an electroformed metal template; wherein the first template comprises a plurality of pores; disposing a layer of a polymeric resin on a viewing surface; pressing the electroformed metal template against the polymeric resin; and solidifying the polymeric resin.

Disclosed herein too is a method of manufacturing an antireflective viewing surface comprising electroforming a metal upon a first template to form an electroformed metal template; wherein the first template comprises a plurality of pores; disposing a layer of a curable resinous material on a viewing surface; pressing the electroformed metal template against the viewing surface; and curing the curable resinous material to form a thermosetting resin.

Disclosed herein too is a method of manufacturing an electroformed metal template comprising disposing a first template comprising an anodized aluminum oxide porous surface in an electroforming tank comprising a metal salt; applying a voltage between the tank and the anodized aluminum oxide porous surface; disposing a metal onto the anodized aluminum oxide porous surface to form an electroformed metal template; and removing the metal template from the anodized aluminum oxide object.

Disclosed herein too is a method of manufacturing an antireflective viewing surface comprising disposing a layer of a curable resinous material on a viewing surface; pressing a first template against the viewing surface; wherein the first template comprises a metal oxide that has aperiodic pores that have aspect ratios of about 1 to about 5; and curing the curable resinous material to form a thermosetting resin.

Disclosed herein too is a method of manufacturing an antireflective viewing surface comprising disposing a layer of a curable resinous material on a first metal template; wherein the first template comprises a metal oxide that has aperiodic pores that have aspect ratios of about 0.5 to about 5; curing the curable resinous material to form a textured layer; and disposing the textured layer on a viewing surface to form the antireflective viewing surface.

Disclosed too is a composition comprising a metal oxide layer, wherein the metal oxide layer comprises pores having aspect ratios of about 0.5 to about 5.

Disclosed herein too is a composition comprising a metal oxide layer, wherein the metal oxide layer comprises tapered pores having a height to maximum diameter ratio of about 1 to about 10.

Disclosed herein too are articles comprising the antireflective surface.

### DESCRIPTION OF THE FIGURES

FIG. 1 depicts a schematic illustration of an exemplary process for manufacturing the first template when the first template comprises a plurality of substantially cylindrical pores;

FIG. 2 depicts a schematic illustration of an exemplary process for manufacturing the first template when the first template comprises a plurality of substantially tapered pores;

FIG. 3 is a schematic illustration of an exemplary process for manufacturing the antireflective viewing surface;

FIG. 4 is a schematic illustration of an exemplary embodiment for manufacturing the antireflective viewing surface when the electroformed metal template is converted into a cylinder and used as a roll in a nip coater or roll mill;

FIG. 5 shows two scanning electron micrographs in FIGS. 5(a) and 5(b) respectively that depict aluminum anodized for differing time periods; FIG. 5(a) shows a film that has pores that are 170 nm deep upon being anodized for 81 seconds while FIG. 5(b) shows a film that has pores that are 220 nm deep that was anodized for 150 seconds;

FIG. 6 depicts scanning electron micrographs (SEM) of a sample at two different magnifications; FIG. 6(a) is a low magnification SEM image (taken at a magnification of 30,000×), showing the full thickness of the AAO and the remaining metal; FIG. 6(b) is a higher magnification (taken at a magnification of 100,000×) depicting narrow pore walls and wide pores created by the pore widening etch;

FIG. 7 comprises three photomicrographs —FIGS. 7(a), 7(b) and 7(c) respectively; FIG. 7(a) shows a cross-sectional image of the full film thickness fracture cross-section; FIG. 7(b) shows a cross-sectional image of the top layer and the transition to the bottom layer fracture cross-section; FIG. 7(c) shows the oblique angle view of the fracture edge and top surface;

FIG. 8 comprises three scanning electron micrographs that show the pores after being subjected to different degrees of a pore widening etch; FIG. 8(a) shows pores that were not subjected to any pore widening wherein the average pore diameter is 33 nanometers; FIG. 8(b) shows pores widened at 25° C. for 30 minutes wherein the average pore diameter is 41 nanometers; FIG. 8(c) shows pores widened at 25° C. for 61 minutes wherein the average pore diameter is 60 nanometers;

FIG. 9 depicts an exemplary method of roll coating a polymeric sheet with a textured layer to form an anti-reflective viewing surface;

FIG. 10 depicts a) an anodic aluminum oxide layer having an aspect ratio of about 2 and b) the corresponding antireflective viewing surface manufactured by using the anodic aluminum oxide layer as a template;

FIG. 11 depicts a) a nanotextured aluminum surface produced by etching an anodic aluminum oxide surface to remove the anodic aluminum oxide and b) the corresponding antireflective viewing surface manufactured by using the nanotextured aluminum surface as a template; and

FIG. 12 depicts a) an anodic aluminum oxide layer with tapered pores having a height to maximum diameter ratio of about 3 and b) the corresponding antireflective viewing surface manufactured by using the anodic aluminum oxide layer as a template.

### DETAILED DESCRIPTION

The terms “first,” “second,” and the like as used herein do not denote any order, quantity, or importance, but rather are used to distinguish one element from another. The terms “a” and “an” do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). As used herein, the term “(meth)acrylate” encompasses both acrylate and methacrylate groups.

Disclosed herein is a method of manufacturing antireflective viewing surfaces that comprise protrusions having widths of about 25 nanometers (nm) to about 300 nm and heights of about 25 to about 1,000 nm. Disclosed herein is a method of manufacturing an electroformed metal template that is used to manufacture the protrusions that have widths of about 25 to about 300 nm and heights of about 25 to about 1,000 nm on the antireflective viewing surface.

Disclosed herein too is a method of manufacturing antireflective viewing surfaces that comprise pores having widths of about 25 nanometers (nm) to about 300 nm and depths of about 25 to about 1,000 nm. Disclosed herein too is a method of manufacturing an electroformed metal template that is used to manufacture the pores that have widths of about 25 to about 300 nm and depths of about 25 to about 1,000 nm on the antireflective viewing surface.

The antireflective viewing surface is manufactured by disposing a textured layer having protrusions or pores on a viewing surface. The protrusions are generally smaller than the wavelength of light. This method of manufacturing the antireflective viewing surface advantageously provides a means to create a large-area master directly, without seams produced by tiling smaller masters.

The textured viewing layer is manufactured by replicating the structures (pores or protrusions) disposed on a first template or an electroformed metal template directly onto a viewing surface. In another embodiment, the textured viewing layer is manufactured by replicating the structures (pores or protrusions) disposed on a first template or an electroformed metal template onto a layer of polymeric resin disposed on a viewing surface. The texturing of the layer of polymeric resin converts the viewing surface to an antireflective viewing surface.

In one embodiment, an anodic oxidized aluminum surface is used as a first template (i.e., a master) from which a textured layer is created. In one embodiment, an electroformed metal template can be used as a mold to texture viewing surfaces thereby converting them to antireflective viewing surfaces. In another advantageous embodiment, the first electroformed metal template can be used to manufacture additional electroformed metal templates that can be used for texturing viewing surfaces to convert them to antireflective viewing surfaces. This method of manufacturing can generate large, stable reusable templates, eliminating the need to successively texture small portions of a larger viewing surface until the entire viewing surface is textured. The method advantageously provides a less expensive means to manufacture large antireflective surfaces as compared with methods that employ holographic lithography.

In one embodiment, the method comprises using a plurality of pores manufactured on a substrate as a first template. The plurality of pores serve as a template for manufacturing a textured layer that is disposed upon a viewing surface to create an antireflective viewing surface. In another embodiment, the plurality of pores serve as a first template for an electroforming process that is used to manufacture the electroformed metal template. The electroformed template is a replica of the first template. A parent electroformed metal template can be used to manufacture children electroformed metal templates that have either a positive image or a negative image of the parent electroformed metal template. The electroformed metal template can further be used to form a textured layer having either a negative image or a positive image of the electroformed metal template.

For example, if the first template comprises a porous structure, then the electroformed metal template which is the replica of the first template can be used to create a textured layer having pores or protrusions depending upon whether the negative image or the positive image of the electroformed metal template is used for the texturing.

A first template comprising a textured surface pattern can be generated by the anodization of an aluminum layer to provide an anodic aluminum oxide layer. The textured surface pattern generated in the anodic aluminum oxide layer can be transferred directly to a surface of a variety of polymeric materials to provide an antireflective viewing surface. Alternatively, the textured surface pattern of the first template can be transferred to other templates, such as an electroformed metal template, which can then be used to transfer the textured surface pattern to a variety of polymer materials.

In one embodiment, the electroformed metal template serves as a parent that is used in an electroforming process wherein additional electroformed metal templates, or children, which are replicas of the parent, are obtained. In another embodiment, the child electroformed metal templates can also be used to directly manufacture protrusions on a selected viewing surface to render the surface antireflective.

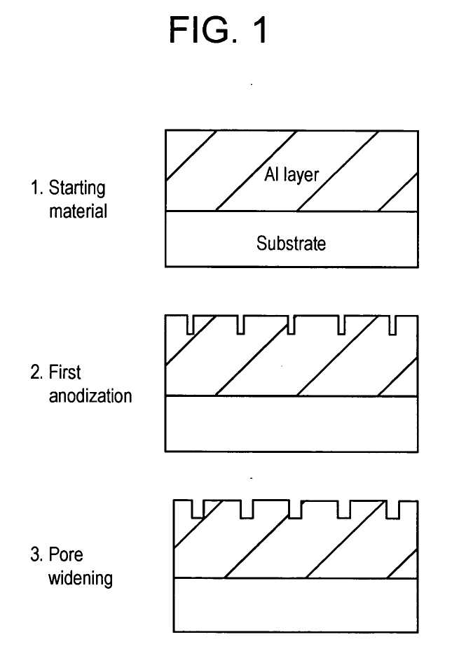

In one embodiment, a first template is created in an aluminum substrate by the anodization of aluminum. The anodization process promotes a self-assembly process that results in the formation of pores in a layer of aluminum oxide that is disposed on the aluminum substrate. The anodization process creates pores in an anodic aluminum oxide layer adjacent to an aluminum substrate. Suitable examples of aluminum substrates are aluminum film, foils, sheets, plates, drums, rollers, or the like. In the case of the aluminum film, the film can be supported on a flat or curved substrate as desired for the application. The example in FIG. 1 depicts an aluminum film supported on a flat silicon wafer substrate.

The anodic aluminum oxide (AAO) layer comprises a plurality of substantially uniform and substantially parallel pores that are substantially perpendicular to the upper surface of the anodic aluminum oxide. The pores are substantially parallel to the vertical. The upper surface of the anodic aluminum oxide is the surface that contains the openings of the pores. The upper surface of the anodic aluminum oxide is the surface that contacts the air. The lower surface of the anodic aluminum oxide contacts the aluminum substrate. The plurality of pore openings on the surface of the AAO layer is formed by electrochemical anodization of aluminum using electrolytes that promote electric field assisted oxide dissolution. While the examples described herein use an aluminum starting material; it is contemplated that other materials can be anodized to form a suitable plurality of pore openings disposed upon the surface. Examples include silicon, titanium, tantalum, aluminum alloys, or the like, or a combination comprising at least one of the foregoing materials. Exemplary alloys are aluminum alloys of the 1100 series and the 6000 series. These are suitable alternatives in particular applications.

By anodizing aluminum in an acid electrolyte such as, for example, sulfuric acid, oxalic acid, phosphoric acid, citric acid, or the like, the AAO layer thus formed spontaneously assumes a textured surface pattern comprising pores that are substantially cylindrical; substantially hemispherical; substantially tapered; or having other desirable morphologies. For example, as shown in FIG. 1, an anodization step optionally followed by a pore-widening step can create a plurality of substantially uniform and substantially cylindrical pores. The anodization of the aluminum layer results in either a random or a self-organized assembly of pores on the surface of the AAO layer. Following the anodization process, the surface features of the AAO layer can be modified, for example, by etching the AAO layer, such as by etching in dilute phosphoric acid, or by removal of the aluminum oxide layer to expose the texture impaired by the anodization to the underlying aluminum layer. The shape and size of the pores determine the eventual antireflective performance of the antireflective viewing surface.

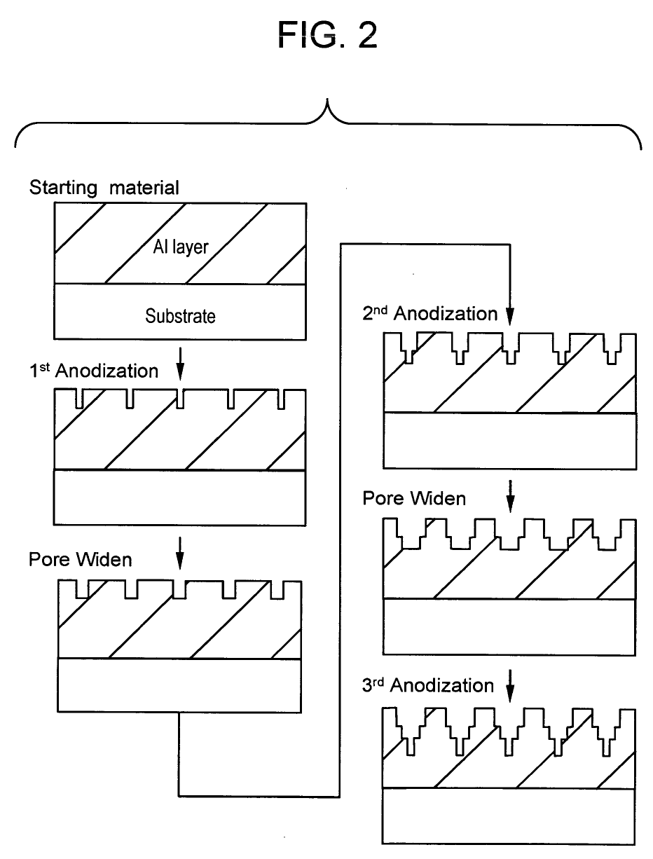

In another embodiment according to FIG. 2, a general schematic overview is provided that depicts a multistep process comprising alternating anodization steps and pore-widening steps to provide tapered pores on the surface of an AAO layer. The starting material can comprise an aluminum layer. The aluminum layer can be disposed upon a substrate comprising metals such as titanium. In another embodiment, the aluminum layer can be disposed upon a substrate comprising titanium and silica. In the first anodization step, the aluminum can be anodized in a first acid to manufacture a first set of pores. In a first pore-widening step, the pores formed by the first anodization are widened. In order to effect the pore-widening step, the aluminum layer with the pores can be subjected to a second acidic treatment using a second acid. The first acid and the second acid can be the same or different.

It is generally desirable to use a voltage of about 10 to about 200 volts during the anodization. Phosphoric acid is an exemplary acid for use as the first acid and the second acid.

Subsequent to the first pore-widening step, a second anodization step is performed to provide a second set of pores at the bottom of the first set of widened pores. The second set of pores are subsequently widened by a second pore-widening step. A third anodization step is then performed to provide a third set of pores at the bottom of the second set of widened pores. By using such anodization conditions combined with appropriate pre- and post-processing of the aluminum and aluminum oxide, the morphology of the AAO surface can be used as a template for imparting moth-eye type antireflective surface behavior to the viewing surface. All of the structures displayed in the FIG. 2, can be used to manufacture textured layers that can be disposed on a viewing surface to create the antireflective viewing surface. Both the single layer non-tapered structures or the tapered structures generated over multiple layers can be effectively used to manufacture textured layers that can be disposed on a viewing surface to create the antireflective viewing surface.

In general in order to achieve good antireflective performance without substantial scattering of visible light, the pores in the anodic aluminum oxide have an average depth of about 25 to about 1,000 nm and a width of about 25 to about 300 nm. In one embodiment, the average depth can be about 50 to about 750 nm. In another embodiment, the depth can be about 75 to about 500 nm. An exemplary average depth is about 200 to about 300 nm. In one embodiment, the average width can be about 50 to about 300 nm. In another embodiment, the average width can be about 75 to about 175 nm. An exemplary average width is about 200 to about 250 nm with an average spacing between pores of about 200 to about 250 nm. Exemplary pores have a depth of about 200 to about 300 nm.

In one embodiment, the pores can have an aspect ratio of about 0.5 to about 5. The aspect ratio of the pore is the ratio of its depth to its width. In another embodiment, the pores can have an aspect ratio of about 2 to about 4. In yet another embodiment, the pores can have an aspect ratio of about 1 to about 3.

When the pores are tapered, the ratio of the depth to the maximum diameter can be about 1 to about 10. In one embodiment, the ratio of the depth to the maximum diameter for tapered pores is about 2 to about 8. In another embodiment, the ratio of the depth to the maximum diameter for tapered pores is about 3 to about 7.

It is to be noted that variations of this general scheme can be employed to provide a textured surface comprising various shapes and sizes of pores. For example, the number of steps may be increased or decreased. Further, a tapered pore can be provided by multiple anodization steps that vary by, for example, duration, voltage, electrolyte composition, temperature, time, or the like, without an intervening pore-widening step.

The first template comprising the textured surface pattern thus produced can be replicated directly by imparting its textured surface pattern to a UV-curable layer that is disposed on a plastic or glass viewing surface. In one embodiment, the UV-curable layer is disposed upon the viewing surface and the first template is directly pressed onto the UV-curable layer. The UV-curable layer is then cured to form a textured layer, following which the first template is removed. The presence of the textured layer upon the viewing surface converts the viewing surface to an antireflective viewing surface. In another embodiment, a UV-curable layer is disposed upon the first template and cured on the first template to form a textured layer. The textured layer is then removed and disposed upon a viewing surface to form an anti-reflective viewing surface.

An electroformed metal template having a negative image of the surface of AAO layer comprising a plurality of pore openings (i.e., the first template) can then be manufactured in an electroforming process. A positive image electroformed metal template can subsequently be manufactured from the negative image electroformed metal template. Electroforming is a process wherein electroplating is utilized to dispose metal on the first template in such a manner that the electroplated layer can subsequently be removed from the first template. In one embodiment, the electroformed metal template can comprise nickel, silver, gold, copper, cadmium, chromium, magnesium, platinum, palladium, cobalt, or the like, or a combination comprising at least one of the foregoing metals. In an exemplary embodiment, the electroformed metal template comprises nickel. In another exemplary embodiment, the electroformed metal template comprises a nickel cobalt alloy.

In the manufacturing of the electroformed metal template from a first template comprising an electrically insulating surface, such as AAO, the surface of the first template has to be seeded in order to facilitate the deposition of the metal on the first template. The purpose of the seeding is to provide a conductive surface onto which metal can be plated during the electroforming process. This can be accomplished by several methods. In one embodiment, the electrically insulating surface can be made conductive through electroless plating. An exemplary electroless plating process comprises depositing a metal such as silver on to the electrically insulating surface by the reduction of silver nitrate using a mild reductant such as formaldehyde. An alternative process comprises preparing the electrically insulating first-template surface for electroforming by vacuum depositing a metal on to its surface. Examples of vacuum deposition processes that can be used to deposit metal are thermal evaporation, electron-beam evaporation, or sputtering.

The electroformed metal template can have an average thickness of about 20 micrometers (μm) to about 5 millimeters (mm). In one embodiment, the electroformed metal template can have an average thickness of about 50 μm to about 4 mm. In another embodiment, the electroformed metal template can have an average thickness of about 100 μm to about 3 mm. In yet another embodiment, the electroformed metal template can have an average thickness of about 500 μm to about 2 mm. In yet another embodiment, the electroformed metal template can have an average thickness of about 100 μm to about 300 μm. When roll-to-roll coating is performed, it is desirable for the electroformed metal template to have an average thickness of about 100 μm to about 300 μm.

In one embodiment, the method of manufacturing an electroformed metal template comprises placing the first template into a tank comprising a solution that contains the metal that is incorporated into the electroformed metal template. An exemplary solution for manufacturing a nickel electroform is nickel sulfamate with some boric acid. Once the template has been placed into the electroforming tank, a voltage is applied to the template and a counter electrode for a period of time sufficient to generate the electroformed metal template. The counter electrode comprises bulk metal of the same type being deposited on the template. The applied voltage induces the flow of electrical current between the template and the counter electrode. The positive metallic ions in the solution are attracted to the negatively charged template. The metallic ions are disposed on the template generating the electroformed metal template. In one embodiment, the current is applied to the template and the tank for a time period greater than or equal to about 1 hour. In one embodiment, the current is applied to the template and the tank for a time period greater than or equal to about 5 hours. In another embodiment, the current is applied to the template and the tank for a time period greater than or equal to about 15 hours. In yet another embodiment, the current is applied to the template and the tank for a time period greater than or equal to about 30 hours. An exemplary time period is about 3 to about 18 hours.

Once the electroformed metal template is manufactured, the first template can be removed from the electroformed metal template. The first template can be removed by dissolution in a solvent, mechanical abrasion, thermal or chemical degradation, or the like. In another embodiment, the first template is removed from the electroformed metal template by using a wedge to separate the material. In another embodiment the electroformed metal template is removed from the first template by separating the edge and peeling the electroformed metal template off. After the first template has been removed, the resulting electroformed metal template will comprise structures that are suitable for manufacturing the desired antireflective structures on a viewing surface. This resulting electroformed metal template is termed the negative image electroformed metal template and can be used as a template to electroform a positive image electroformed metal template. In one embodiment, the first template can be used to produce many electroformed metal templates. In another embodiment, each electroformed metal template can be used to produce many additional electroformed metal templates.

The electroformed metal template comprises surface features that are positive images or negative images of the surface features of the plurality of pore openings contained in the first template. The electroformed metal template comprises a plurality of pores having average widths of about 25 to about 300 nanometers (nm) and average depths of about 25 to about 1,000 nm. In one embodiment, the average depth of the pores of the electroformed metal template can be 50 to about 800 nm. In another embodiment, the average depth of the pores of electroformed metal template can be about 100 to about 500 nm. An exemplary average depth is about 200 to about 400 nm. In another embodiment the average width of the pores of electroformed metal template can about 75 to about 300 nm. An exemplary average width is about 150 to about 250 nm.

The electroformed metal template is then optionally examined for defects and may optionally be subjected to finishing processes. The examination is conducted for quality control purposes and is undertaken to remove surface defects and distortions. After the examination, the electroformed metal template can be subjected to a finishing operation if desired. The finishing operation may include mechanical or chemical finishing operations such as buffing, lapping, electroplating, electropolishing, or the like, or a combination comprising at least one of the foregoing finishing operations.

In one embodiment, the electroformed metal template can be used to generate antireflective structures such as, for example, protrusions on a viewing surface. The viewing surface after the generation of protrusions is referred to as an antireflective viewing surface.

The electroformed metal template comprising a plurality of pores can be used to manufacture antireflective structures on the viewing surface that minimize reflection. In one embodiment, the electroformed metal template can be used to manufacture either a negative image or a positive image of the plurality of pores (similar to those on the first template) on a selected viewing surface.

The electroformed metal template or a child template derived from the electroformed metal template allows for the replication of textured surface patterns in a variety of materials. The electroformed metal templates or the child templates can be used repeatedly to pattern coatings or bulk materials by casting and curing processes (e.g., UV-cured acrylate or silicone coatings on polymer films) or by other casting or molding processes (e.g., solvent casting, calendaring, compression molding, or injection molding). In addition, electroformed metal templates or child templates having a large area can be produced by this method providing for textured layers on antireflective viewing surfaces that have large areas such as, for example, those used in electronic displays, including computer monitors and televisions, including those 32 inches or larger. Further, since the surface of the electroformed metal templates or child templates are not restricted to being flat, a cylindrical drum that permits the manufacturing of a seamless child template can be produced. Additionally, the child template can be produced after other structures have been previously formed on the template, such as, for example longer-wavelength, larger feature-size anti-glare patterns, thus providing improved antiglare performance in addition to providing antireflective performance.

The electroformed metal template and/or the child template can be used to repeatedly replicate the textured surface pattern in a variety of optically suitable materials to manufacture and antireflective viewing surface. In other words, the textured layer can comprise metals, ceramics and polymeric resins.

The polymeric resins can be thermoplastic resins and/or thermosetting resins. These materials comprise optically clear thermoplastics such as polymethylmethacrylate, polycarbonate, polyester, polyolefin copolymers, cellulose acetate butyrate, polystyrene, or the like, or a combination comprising at least one of the foregoing thermoplastics. Other suitable materials include curable materials, such as, for example, optically transparent thermosetting resins such as epoxy or polydimethylsiloxane; optically transparent radiation curable resins, such as acrylates, methacrylates, urethane acrylates, epoxy acrylates, polyester acrylates; or the like, or a combination comprising at least one of the foregoing thermoplastics.

The manufacturing of antireflective structures on the viewing surface causes a texturing of the viewing surface. Since the depth of the pores, and the height of the corresponding protrusions, is about 25 to about 1,000 nanometers, this texturing of the viewing surface produces antireflective properties. In other words, the size of the protrusions or pores manufactured on an antireflective viewing surface are less than about half the wavelength of visible light. When the size of the protrusions or pores is less than about half the wavelength of visible light, the reflection of light from the antireflective viewing surface is suppressed.

The antireflective viewing surface is generally manufactured by disposing a textured layer comprising the protrusions or pores upon the viewing surface. The textured layer generally comprises a polymeric resin such as, for example, a thermosetting resin or a thermoplastic resin. This can be accomplished in a batch manufacturing process or in a continuous manufacturing process. In one embodiment, the textured layer generally comprises a thermosetting resin, while the viewing surface comprises an optically transparent thermoplastic resin. In another embodiment, the textured layer generally comprises a thermosetting resin, while the viewing surface comprises an optically transparent ceramic such as, for example, glass. The ceramic can be optionally coated with a thermoplastic resin or a thermosetting resin for purposes of improving adhesion or abrasion resistance. In yet another embodiment, a viewing surface comprising a thermoplastic resin can be directly textured using the electroformed metal template. In another embodiment, a thermoplastic film can be textured using the electroformed metal template. The thermoplastic film can then be disposed upon the viewing surface. The viewing surface is then converted into an antireflective viewing surface.

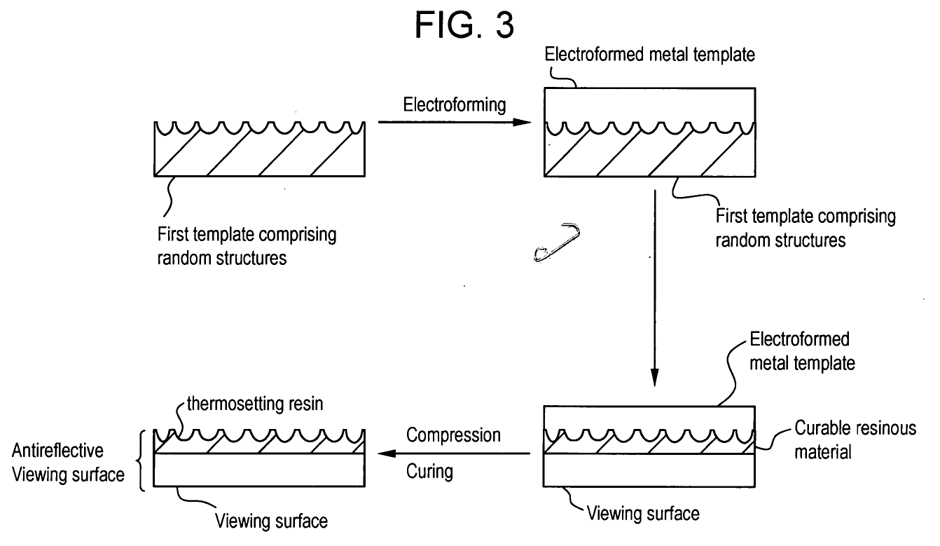

With reference to the FIG. 3, in one embodiment, in one method of manufacturing the antireflective viewing surface, a layer of a curable resinous material is disposed upon the viewing surface. The first template or the electroformed metal template is then disposed upon the layer of curable resinous material. The first template or electroformed metal template together with the viewing surface and the layer of curable resinous material disposed therebetween is then subjected to compression to remove any excess curable resinous material. The compression of the first template or electroformed metal template against the viewing surface can be accomplished in a press, a roll mill, a nip roll assembly, or the like. After the removal of excess curable resinous material, the curable resinous material is activated to undergo curing. The curable resinous material upon undergoing curing forms a thermosetting resin. After the curing reaction is substantially complete, the first template or the electroformed metal template is removed from the antireflective viewing surface. In one embodiment, the curing reaction can be activated by ultraviolet light, microwave radiation, radio frequency radiation, infrared radiation, or the like. In an exemplary embodiment, the curing reaction is activated by ultraviolet light.

The curing reaction can also be activated by heat. In another embodiment, the curing reaction can be activated by placing the first template or the electroformed metal template, the viewing surface and the curable resinous material disposed therebetween in an oven and raising the temperature of the oven to a value that is greater than that required to cure the curable resinous material. The curing in the oven is generally carried out after the compression of the template against the viewing surface has occurred. The curable resinous material undergoes curing to form a thermosetting resin thereby producing a textured layer.

The combination of the viewing surface with the textured layer is referred to as the antireflective viewing surface. The textured layer can be disposed upon both sides of the viewing surface to further reduce reflection.

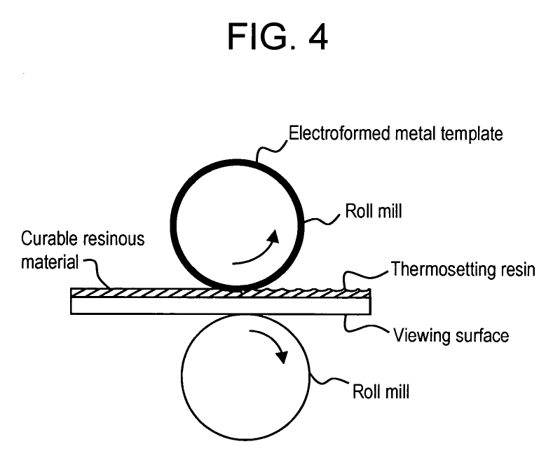

In another embodiment depicted in the FIG. 4, in another method of manufacturing the antireflective viewing surface, the electroformed metal template can be bent into the form of a cylinder. The cylindrical electroformed metal template is then pressed into the curable resinous material (that is disposed on the viewing surface) to manufacture an antireflective viewing surface. The curing of the curable resinous material can begin prior to, during or after the cylindrical electroformed metal template is pressed against the viewing surface. In the embodiment depicted in the FIG. 4, the electroformed metal template can be bent into the form of a cylinder by disposing it on a roll of a roll mill or a casting nip assembly. As the viewing surface with the curable resinous material is passed through the roll mill or the casting nip assembly, the cylindrical electroformed metal template is pressed into the viewing surface to manufacture the antireflective viewing surface.

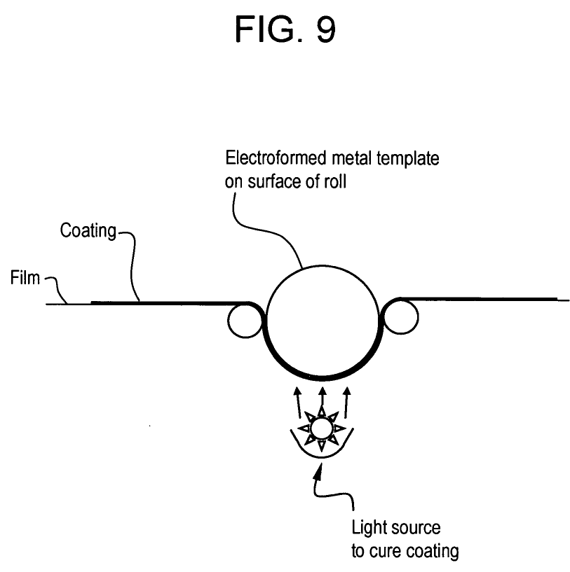

In yet another embodiment, depicted in the FIG. 9, a UV-curable resin is disposed upon a transparent polymeric sheet. The transparent polymeric sheet with the UV-curable resin disposed thereon is passed through a cylindrical roll coating system. At least one of the rolls in the cylindrical roll coating system has disposed upon its surface a first template or an electroformed metal template that contacts the UV-curable resin and produces an image of its surface texture into the TV-curable resin. The UV-curable resin is cured to form a textured layer upon the transparent polymeric sheet. The transparent polymeric sheet together with the textured polymeric sheet disposed thereon can be used as an antireflective viewing surface.

As noted above, the viewing surface generally comprises a thermoplastic resin. In one embodiment, it is desirable for the thermoplastic resin to be optically transparent. It is desirable for the thermoplastic resin to have a transmission for visible light that exceeds 75%. In another embodiment, it is desirable for the thermoplastic resin to have a transmission that exceeds 85%. In yet another embodiment, it is desirable for the thermoplastic resin to have a transmission that exceeds 90%. Examples of suitable thermoplastic resins are polycarbonate, polyethylene terephthalate, polyacrylate, polymethylmethacrylate, polystyrene, styrene acrylonitrile (SAN) resins, cellulose acetate, or the like, or a combination comprising at least one of the foregoing thermoplastic resins. In an exemplary embodiment, the viewing surface comprises polycarbonate. In another exemplary embodiment, the viewing surface comprises polyethylene terephthalate.

As noted above, in one embodiment, a viewing surface comprising a thermoplastic resin can be fabricated into an antireflective viewing surface. In this embodiment, the electroformed metal templates are pressed against the viewing surface. The temperature of the viewing surface can be raised to around the glass transition temperature of the thermoplastic resin during the pressing. Upon texturing the viewing surface, the temperature is lowered until the thermoplastic resin solidifies. The electroformed metal template is then removed.

In another embodiment relating to the use of thermoplastic films, a thermoplastic film can be textured by pressing an electroformed metal template against it. The textured film can then be disposed upon a viewing surface and held in position by using an adhesive layer between the textured thermoplastic film and the viewing surface, such as by lamination.

The viewing surface can comprise additional layers disposed thereon, such as, for example, a primer layer, an adhesive layer, an abrasion resistant layer, or the like. When the viewing surface comprises an additional layer such as a primer layer or an adhesive layer, the additional layer is generally disposed between the textured layer and the viewing surface.

It is desirable for the curable resinous materials to be cured using electromagnetic radiation to form the thermosetting resin of the textured layer. An exemplary form of electromagnetic radiation is ultraviolet radiation. Examples of curable resinous materials that can be used to form the textured layer are acrylates, methacrylates, epoxies, phenolics, polyurethanes, silicones, or the like, or a combination comprising at least one of the foregoing materials.

In embodiments comprising a curable coating, the curable coating comprises a curable composition, which generally comprises a polymerizable compound. Polymerizable compounds, as used herein, are monomers or oligomers comprising one or more functional groups capable of undergoing radical, cationic, anionic, thermal, and/or photochemical polymerization. Suitable functional groups include, for example, acrylate, methacrylate, vinyl, epoxides, or the like.

In one embodiment, the curable composition can include monomeric and dimeric acrylates, for example, cyclopentyl methacrylate, cyclohexyl methacrylate, methylcyclohexylmethacrylate, trimethylcyclohexyl methacrylate, norbornylmethacrylate, norbornylmethyl methacrylate, isobornyl methacrylate, lauryl methacrylate 2-ethylhexyl methacrylate, 2-hydroxyethyl methacrylate, hydroxypropyl acrylate, hexanediol acrylate, 2-phenoxyethyl acrylate, 2-hydroxyethyl acrylate, 2-hydoxypropyl acrylate, diethyleneglycol acrylate, hexanediol methacrylate, 2-phenoxyethyl methacrylate, 2-hydroxyethyl methacrylate, 2-hydoxypropyl methacrylate, diethyleneglycol methacrylate, ethylene glycol dimethacrylate, ethylene glycol diacrylate, propylene glycol dimethacrylate, propylene glycol diacrylate, allyl methacrylate, allyl acrylate, butanediol diacrylate, butanediol dimethacrylate, 1,6-hexanediol diacrylate, 1,6-hexanediol dimethacrylate, diethyleneglycol diacrylate, trimethylpropane triacrylate, pentaeryritol tetraacrylate, hexanediol dimethacrylate, diethyleneglycol dimethacrylate, trimethylolpropane triacrylate, trimethylpropane trimethacrylate, pentaeryritol tetramethacrylate, tetrabromobisphenol-A diglycidyl ether diacrylate, phenylthioethyl acrylate or combinations comprising at least one of the foregoing acrylates.

Additionally, the curable composition can comprise a polymerization initiator to promote polymerization of the curable components. Suitable polymerization initiators include photoinitiators that promote polymerization of the components upon exposure to ultraviolet radiation. Suitable photoinitiators include, but are not limited to benzophenone and other acetophenones, benzil, benzaldehyde and o-chlorobenzaldehyde, xanthone, thioxanthone, 2-chlorothioxanthone, 9,10-phenanthrenenquinone, 9,10-anthraquinone, methylbenzoin ether, ethylbenzoin ether, isopropyl benzoin ether, 1-hydroxycyclohexyphenyl ketone, α,α-diethoxyacetophenone, α,α-dimethoxyacetoophenone, 1-phenyl-,1,2-propanediol-2-o-benzol oxime, 2,4,6-trimethylbenzoyldiphenyl phosphine oxide, α,α-dimethoxy-α-phenylacetopheone, or a combination comprising at least one of the foregoing.

The protrusions or pores can be aperiodically or periodically distributed across the textured layer. Aperiodically as defined herein refers to the fact that there is no periodicity to the protrusions and no long-range order. The protrusions or pores have randomly distributed heights and randomly distributed widths and randomly distributed spacing between the protrusions. The protrusions or pores have cross-sectional geometries in a direction perpendicular to the viewing surface that are conical, triangular, square, semi-circular, polygonal, ellipsoidal, parabolic, sinusoidal, or a combination comprising at least one of the foregoing geometries.

The average widths of the protrusions or pores of the textured layer is about 25 to about 300 nm and the average height (depths in the case of pores) is about 25 to about 1,000 nm. In one embodiment, the average height of the protrusions of the textured layer can be 50 to about 800 nm. In another embodiment, the average height of the protrusions of the textured layer can be about 100 to about 500 nm. An exemplary average height is about 200 to about 400 nm. In another embodiment the average width of the protrusions of the textured layer can about 75 to about 300 nm. An exemplary average width of the protrusions is about 150 to about 200 nm.

The thickness of the textured layer from the viewing surface can be in an amount of 25 nanometers to about 50 micrometers. In one embodiment, the thickness of the textured layer from the viewing surface can be in an amount of 100 nanometers to about 20 micrometers. In another embodiment, the thickness of the textured layer from the viewing surface can be in an amount of 500 nanometers to about 5 micrometers.

As noted above, the antireflective viewing surface can advantageously minimize reflections from a viewing surface. In one embodiment, reflectivity is minimized by an amount of greater than or equal to about 20% from a viewing surface that does not have a textured layer disposed thereon. In another embodiment, reflectivity is minimized by an amount of greater than or equal to about 30% from a viewing surface that does not have a textured layer disposed thereon. In another embodiment, reflectivity is minimized by an amount of greater than or equal to about 50% from a viewing surface that does not have a textured layer disposed thereon. In another embodiment, reflectivity is minimized by an amount of greater than or equal to about 90% from a viewing surface that does not have a textured layer disposed thereon.

The following examples, which are meant to be exemplary, not limiting, illustrate compositions and methods of manufacturing of some of the various embodiments of the antireflective surfaces described herein.

### EXAMPLES

The following examples demonstrate the formation of differentially structured pores on the surface of anodic aluminum oxide. Examples 1 through 4 demonstrate methods that can be used to form the first template.

### Example 1

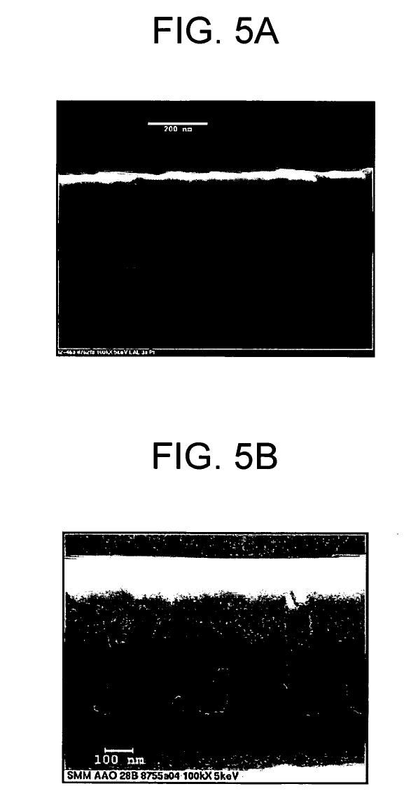

This example was performed to demonstrate the development of pores in an aluminum film. An aluminum film having a thickness of about 1 micrometer was disposed on a titanium film having a thickness of about 50 nanometers that was disposed upon glass. The aluminum was anodized in a solution of 0.3 M oxalic acid at a voltage of 40 volts at room temperature for different durations. FIG. 5 shows two scanning electron micrographs in FIGS. 5(a) and 5(b) respectively that depict aluminum anodized for differing time periods. FIG. 5(a) shows a film that was anodized for 81 seconds. As can be seen from the micrograph, the pores are 170 nm deep. FIG. 5(b) shows a film that was anodized for 150 seconds. As can be seen from the micrograph, the pores are 220 nm deep.

### Example 2

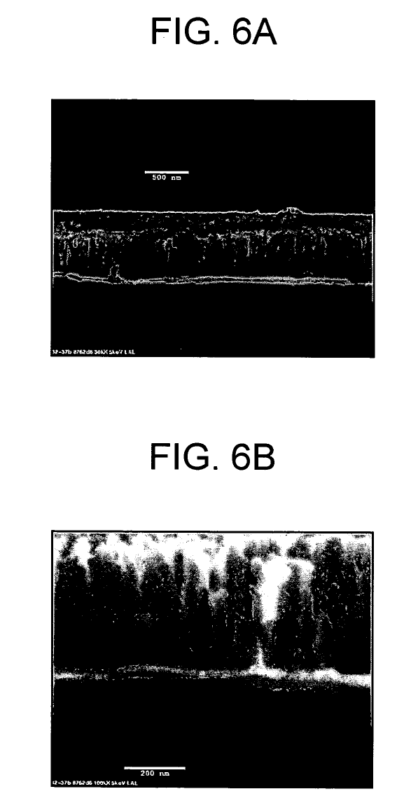

This example was also performed to demonstrate the development of pores in an anodized aluminum oxide layer. It also demonstrates the widening of the pores in the anodized aluminum oxide layer. As described in Example 1 above, the aluminum film was anodized in 0.3 M oxalic acid for 2.5 minutes at 25° C. The voltage applied was 40 volts. Following anodization, the sample was subjected to a pore widening etch in 0.5 M phosphoric acid at 26° C. for 63 minutes. FIG. 6 depicts scanning electron microscope (SEM) micrographs of the sample at two different magnifications. FIG. 6(a) is a micrograph, taken at a magnification of 30,000×, showing the full thickness of the AAO and the remaining metal. The apparent aluminum thickness, the slope, and step in the AAO surface are artifacts of the SEM sample preparation procedure. FIG. 6(b) is a higher magnification SEM image, taken at a magnification of 100,000×, depicting narrow pore walls and wide pores created by the pore widening etch.

### Example 3

This example demonstrates an anodic aluminum oxide layer having pores whose widths change with length. These pores are created by a two-step anodization process which facilitates pore widening. The first anodization and pore widening were explained in Example 2.

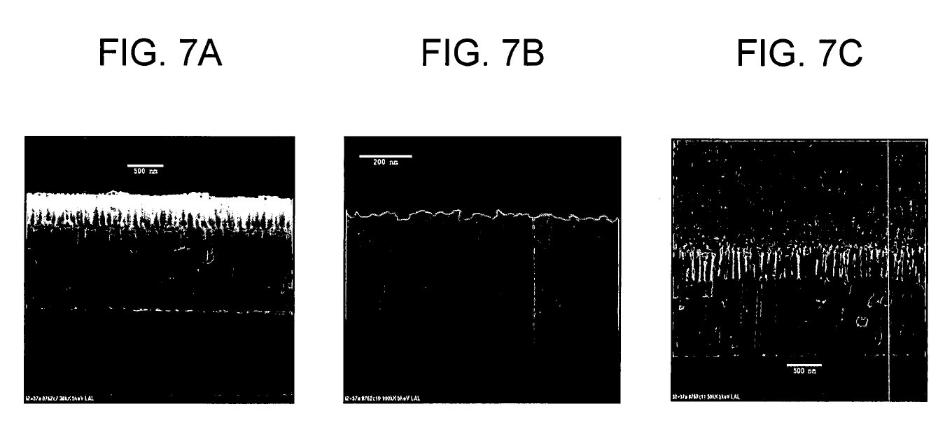

Following the first anodization and pore widening, a second anodization was conducted at 40 V in 0.3 M oxalic acid for 200 seconds, creating narrow pores that originated at the bottoms of the original pores. The pore diameter changes from a large diameter in the 1st region (at the top of the original pores) to a small diameter (at the bottom of the pores created by the second anodization and pore widening). The transition from large to small pores appears to occur gradually over a distance of approximately 30 to 40 nm. FIG. 7 comprises three photomicrographs, FIGS. 7(a), 7(b) and 7(c) respectively that were taken using SEM after the second anodization. FIG. 7(a) shows a cross-sectional image of the full film thickness fracture cross-section. FIG. 7(b) shows a cross-sectional image of the top layer and the transition to the bottom layer fracture cross-section. FIG. 7(c) shows the oblique angle view of the fracture edge and top surface. From the figures, it can be seen that the pores have two portions, an upper cylindrical portion and a lower cylindrical portion. The upper cylindrical portion has an average diameter that is substantially larger than the lower cylindrical portion. The upper cylindrical portion has the larger diameter because it was subjected to pore widening, while the lower cylindrical portion has a smaller diameter because it was not subjected to pore widening.

### Example 4

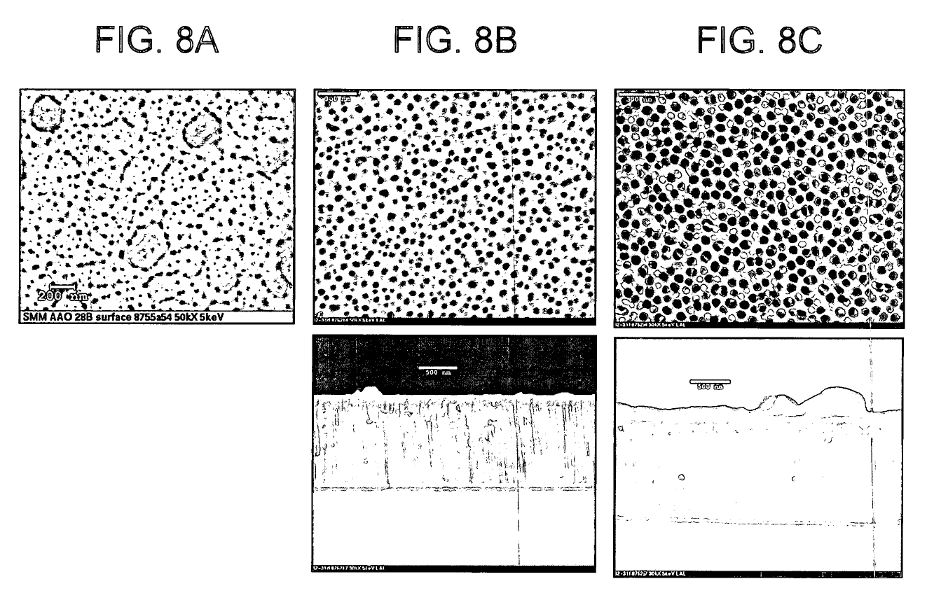

This example demonstrates three AAO films anodized under identical conditions. The procedure used for the anodization is explained in Example 1 above. The samples were then subjected to different degrees of a pore widening etch using 0.5 M phosphoric acid. FIG. 8 contains three scanning electron micrographs that show the pores after being subjected to different degrees of pore widening etch. FIG. 8(a) shows the pores that were not subjected to any pore widening. FIG. 8(b) shows pores widened at 25° C. for 30 minutes. The average pore diameter is 41 nanometers and the average pore depth is about 800 nm. FIG. 8(c) shows pores widened at 25° C. for 61 minutes. The average pore diameter is 60 nanometers while the average pore depth is about 800 nm. The pores formed have cylindrical shapes. This example shows that the pore diameter can be changed substantially without any substantial changes to the pore height. It also shows that by repeatedly performing pore-widening steps, pores having aspect ratios of about 1 to about 5 can be obtained.

### Example 5

This example was performed to demonstrate the development of an antireflective viewing surface. In this example, an aluminum film was anodized at 100 V in 0.5 M phosphoric acid for 1,000 seconds, with a starting temperature of 8° C., using an aluminum bar as the cathode. Throughout the anodization the film was cooled by a chiller block attached to the back-side of the substrate. The aluminum film was prepared by sputtering 1 micron of aluminum atop 50 nm of titanium, which was sputtered on a silicon wafer substrate. Following anodization, the AAO was subjected to a pore widening etch in 0.5 M phosphoric acid at 25° C. for 70 minutes, to form the first template.

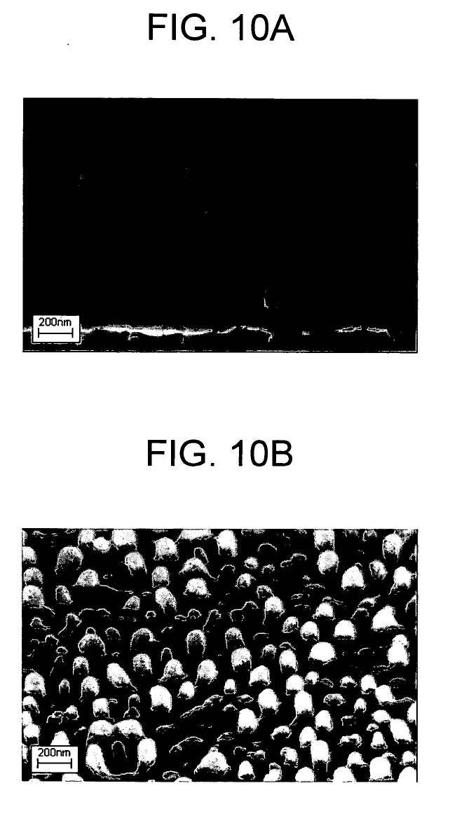

The anodized aluminum oxide layer is depicted in FIG. 10(a). From the FIG. 10(a), it may be seen that the pores have a diameter of approximately 100 nanometers, a depth of approximately 180 nanometers, and a period of approximately 200 nm. The anodized aluminum oxide layer was then used as a first template to create the textured layer depicted in the FIG. 10(b). FIG. 10(b) depicts an antireflective surface comprising an acrylate polymer disposed on a polycarbonate film.

The antireflective coated film was prepared as follows. The template was placed on an aluminum plate and a sheet of polycarbonate film having a thickness of 7 mils with both surfaces polished was placed on top of the template. This stack was placed in an oven and heated to 43° C. After removal from the oven, the polycarbonate film was lifted up, a bead of coating was deposited along one edge of the template, and the film was replaced. The coating comprised a 60/40 mixture by weight of tetrabromobisphenol-A diglycidyl ether diacrylate and phenylthioethyl acrylate, with 0.25 wt % SILWET 7602® surfactant and 0.5 wt % IRGACURE 819® photoinitiator. The aluminum plate, template, coating, and film stack was then passed through a nip roll assembly with 20 pounds per square inch (psi) pressure at 40 feet per minute to distribute the coating in an even layer between the template and the polycarbonate film. The template, coating, and film were then passed under a gallium-doped mercury UV lamp operating at 600 watts per inch (W/inch), at a speed of 40 feet per minute to cure the coating. The UV lamps emit UV light having a wavelength between 350 and 450 nanometers. The polycarbonate film and coating were then peeled off the template, establishing the textured layer attached to the polycarbonate film.

### Example 6

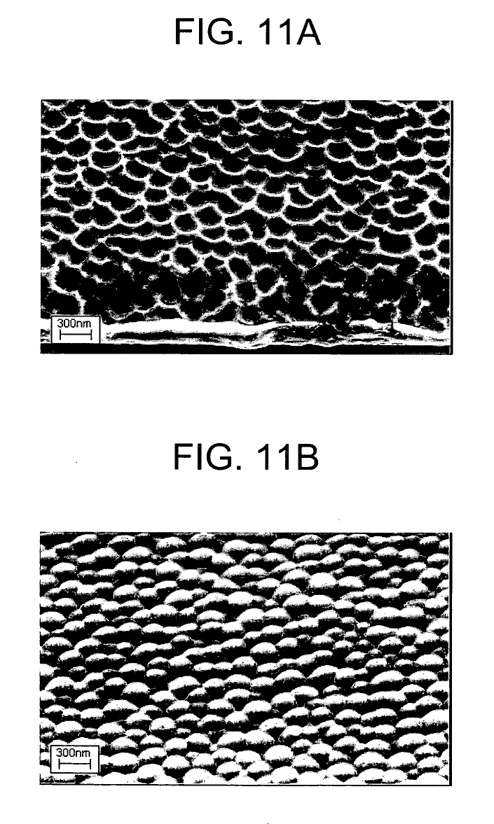

This example was performed to demonstrate the development of an antireflective viewing surface. In this example, an aluminum film was anodized at 100 V in 0.5 M phosphoric acid for 1,000 seconds, starting at a temperature of 5° C., using an aluminum bar as the cathode. Throughout the anodization the film was cooled by a chiller block attached to the back side of the substrate. The aluminum film had been prepared by sputtering 1 micron of aluminum atop 50 nm of titanium, which was sputtered on a silicon wafer substrate. The AAO created by this process was then removed by etching in a solution of 3.5 volume percent phosphoric acid with 45 grams per liter of chromium trioxide, to expose the texture imparted to the remaining aluminum, to form the first template. The nanotextured aluminum surface is depicted in FIG. 11a. From the figure, it may be seen that the pores have a diameter and period of approximately 160 nanometers and a depth of approximately 65 nanometers. The nanotextured aluminum layer depicted in FIG. 11a was then used as a first template to create the textured layer depicted in the FIG. 11b according to the process described in Example 5.

### Example 7

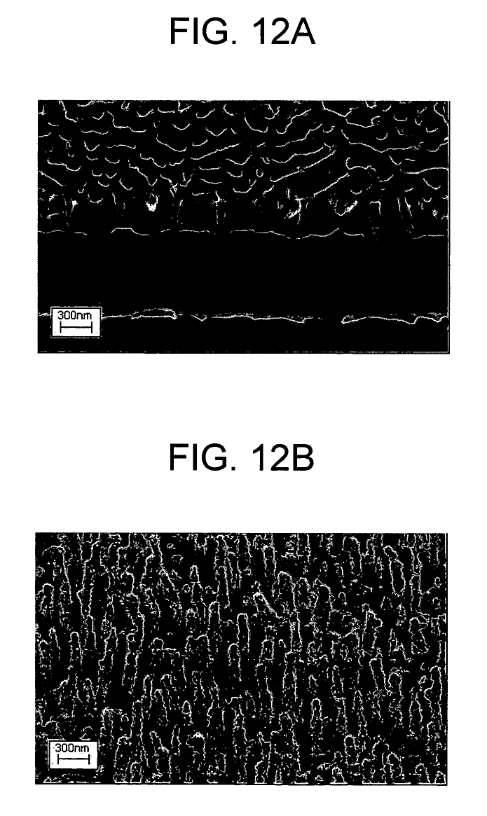

This example was performed to demonstrate the development of an antireflective viewing surface manufactured by replicating a template comprising a surface with tapered pores. In this example, an aluminum film was subjected to a first anodization at 130 V in 0.5 M phosphoric acid for 750 seconds, starting at a temperature of 5° C., using an aluminum bar as the cathode. Throughout the anodization the film was cooled by a chiller block attached to the back side of the substrate. The aluminum film had been prepared by sputtering 1 micron of aluminum atop 50 nm of titanium, which was sputtered on a silicon wafer substrate. Following anodization, the AAO was subjected to a pore widening etch in 0.5 M phosphoric acid at 25° C. for 70 minutes. Following the pore widening etch, the AAO was subjected to a second anodization at identical conditions to those used for the first anodization, to form a first template. The anodized aluminum oxide layer is depicted in FIG. 12a. From the figure, it may be seen that the pores have a maximum diameter at the upper surface of approximately 100 nanometers and a minimum diameter at the bottom of the pores of approximately 65 nanometers, with a smooth transition from the upper substantially cylindrical section to the lower substantially cylindrical section. The overall depth of the pores is approximately 300 nanometers and a period of approximately 230 nanometers. The anodized aluminum oxide layer depicted in FIG. 12a was then used as a first template to create the antireflective surface depicted in the FIG. 12b by the process described in Example 5.

From the above examples, it can be seen that a first template comprising a plurality of pores can be used to manufacture an antireflective viewing surface comprising a textured layer on a viewing surface. Since the textures are smaller than the wavelength of visible light, they are not visible to the naked eye and do not significantly scatter light transmitted through the surface. In addition, since they are smaller than the wavelength of visible light, they create an effective gradient in refractive index that transitions gradually from the ambient atmosphere surrounding the film into the film, thereby reducing the reflection of light and hence they can be used to manufacture antireflective viewing surfaces.

In one embodiment, reflectivity is minimized by an amount of greater than or equal to about 10% from a viewing surface that does not have a textured layer disposed thereon. In another embodiment, reflectivity is minimized by an amount of greater than or equal to about 40% from a viewing surface that does not have a textured layer disposed thereon. In another embodiment, reflectivity is minimized by an amount of greater than or equal to about 60% from a viewing surface that does not have a textured layer disposed thereon. In another embodiment, reflectivity is minimized by an amount of greater than or equal to about 90% from a viewing surface that does not have a textured layer disposed thereon.

As noted above, the textured antireflective surface described herein can be advantageously used in the manufacture of a variety of commercial articles, such as display screens, optical components such as lenses, eyeglasses, face shields, windshields, and greenhouse roofs.

The present method for producing antireflective surface is advantageous in that it can be used to convert large areas of a viewing surface to antireflective viewing surfaces. In one embodiment, a viewing surface having a surface area greater than or equal to about 10 square centimeters (cm²) can be converted into an antireflective surface in a single operation. In another embodiment, a viewing surface having a surface area greater than or equal to about 25 cm² can be converted into an antireflective surface in a single operation. In yet another embodiment, a viewing surface having a surface area greater than or equal to about 50 cm² can be converted into an antireflective surface in a single operation. In yet another embodiment, a viewing surface having a surface area greater than or equal to about 100 cm² can be converted into an antireflective surface in a single operation. In yet another embodiment, a viewing surface having a surface area greater than or equal to about 500 cm² can be converted into an antireflective surface in a single operation. In yet another embodiment, a viewing surface having a surface area greater than or equal to about 1 m² can be converted into an antireflective surface in a single operation.

The presence of the textured layer having protrusions disposed on the viewing surface also advantageously reduces the blue, blue-green or purple reflective haze associated with textured viewing surfaces that have uniformly sized and uniformly distributed antireflective structures.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An antireflective viewing surface comprising:
a viewing surface; and
a textured layer disposed upon the viewing surface; wherein the textured layer comprises a plurality of protrusions that are smaller than the wavelength of light and that are aperiodically distributed across the viewing surface.

2. The antireflective viewing surface of claim 1, wherein the protrusions have cross-sectional geometries in a direction perpendicular to the viewing surface that are circular, triangular, square, semi-circular, polygonal, ellipsoidal, or a combination comprising at least one of the foregoing geometries.

3. The antireflective viewing surface of claim 1, wherein the protrusions have an average height of about 25 to about 1,000 nanometers and an average width of about 25 to about 300 nanometers.

4. The antireflective viewing surface of claim 1, wherein the protrusions have an aspect ratio of about 0.5 to about 5.

5. The antireflective viewing surface of claim 1, wherein the viewing surface comprises polycarbonate, polyacrylate, polymethylmethacrylate, polyester, polystyrene, styrene acrylonitrile resins, cellulose acetate, or a combination comprising at least one of the foregoing thermoplastic resins.

6. The antireflective viewing surface of claim 1, wherein the protrusions are tapered having a height to maximum diameter ratio of about 1 to about 10.

7. The antireflective viewing surface of claim 1, wherein the protrusions comprise a thermosetting resin, and wherein the thermosetting resin is obtained by the reaction of acrylates, methacrylates, epoxies, phenolics, polyurethanes, silicones, or a combination comprising at least one of the foregoing materials.

8. A method of manufacturing an antireflective viewing surface comprising:
electroforming a metal upon a first template to form an electroformed metal template; wherein the first template comprises a plurality of pores;
disposing a layer of a polymeric resin on a viewing surface;
pressing the electroformed metal template against the polymeric resin; and
solidifying the polymeric resin.

9. The method of claim 8, wherein the metal comprises nickel

10. The method of claim 8, wherein the polymeric resin is a thermosetting resin.

11. The method of claim 8, wherein the solidifying comprises curing the polymeric resin.

12. The method of claim 11, wherein the curing is accomplished by irradiating the polymeric resin with ultraviolet light.

13. The method of claim 8, wherein the solidifying comprises lowering the temperature of the polymeric resin.

14. The method of claim 8, wherein the pressing is accomplished in a roll mill or in a nip roll.

15. A method of manufacturing an antireflective viewing surface comprising:
electroforming a metal upon a first template to form an electroformed metal template; wherein the first template comprises a plurality of pores having dimensions that are smaller than the wavelength of light;
disposing a layer of a curable resinous material on a viewing surface;
pressing the electroformed metal template against the viewing surface; and
curing the curable resinous material to form a thermosetting resin.

16. The method of claim 15, further comprising removing the electroformed metal template from the viewing surface.

17. The method of claim 16, further comprising using the electroformed metal template as a parent template for manufacturing children templates that are positive or negative images of the first template.

18. The method of claim 17, further comprising using the children templates to manufacture antireflective viewing surfaces.

19. An article comprising the antireflective surface of claim 1.

20. An article manufactured by the method of claim 8.

21. An article manufactured by the method of claim 15.

22. An article manufactured by the method of claim 18.

23. A method of manufacturing an electroformed metal template comprising:
disposing a first template comprising an anodized aluminum oxide porous surface in an electroforming tank comprising a metal salt;
applying a voltage between the tank and the anodized aluminum oxide porous surface;
disposing a metal onto the anodized aluminum oxide porous surface to form an electroformed metal template; and
removing the electroformed metal template from the anodized aluminum oxide object.

24. The method of claim 23, wherein the first template comprises pores having an average depth of about 25 to about 1,000 nanometers and an average width of about 25 to about 300 nanometers.

25. The method of claim 23, wherein the metal is nickel or a nickel-cobalt alloy.

26. The method of claim 23, further comprising using the electroformed metal template as a parent template for manufacturing a child template.

27. The method of claim 26, wherein the child template is a negative image or a positive image of the first template.

28. A method of manufacturing an antireflective viewing surface comprising:
disposing a layer of a curable resinous material on a viewing surface;
pressing a first template against the viewing surface; wherein the first template comprises a metal oxide that has aperiodic pores that have aspect ratios of about 0.5 to about 5; and
curing the curable resinous material to form a thermosetting resin.

29. The method of claim 28, wherein the metal oxide comprises anodized aluminum oxide.

30. An article manufactured by the method of claim 28.

31. A composition comprising:
a metal oxide layer, wherein the metal oxide layer comprises pores having aspect ratios of about 0.5 to about 5.

32. The composition of claim 31, wherein metal oxide is aluminum oxide.

33. The composition of claim 31, wherein the pores have an average depth of about 25 to about 1,000 nanometers and an average width of about 25 to about 300 nanometers.

34. A composition comprising:
a metal oxide layer, wherein the metal oxide layer comprises tapered pores having a height to maximum diameter ratio of about 1 to about 10.

35. The composition of claim 34, wherein metal oxide is aluminum oxide.

36. The composition of claim 34, wherein the pores have an average diameter of 25 to 300 nanometers and an average height of about 25 to about 1,000 nanometers.

37. A method of manufacturing an antireflective viewing surface comprising:
disposing a layer of a curable resinous material on a first template; wherein the first template comprises a metal oxide that has aperiodic pores that have aspect ratios of about 0.5 to about 5;
curing the curable resinous material to form a textured layer; and
disposing the textured layer on a viewing surface to form the antireflective viewing surface.

38. The method of claim 37, wherein the metal oxide comprises anodized aluminum oxide.

39. An article manufactured by the method of claim 37.

40. A method comprising:
anodizing aluminum in an first acid to create a plurality of pores in the anodized aluminum;
immersing the anodized aluminum in a second acid; and
changing the dimensions of the plurality of pores; wherein the plurality of pores have an average aspect ratio of about 0.5 to about 5 and further have dimensions that are smaller than the wavelength of light;

41. The method of claim 40, wherein the first acid and the second acid are the same.

42. The method of claim 40, wherein the first acid and the second acid are different.

43. The method of claim 40, wherein the first acid and the second acid are phosphoric acid.

44. The method of claim 40, wherein the aluminum is in the form of a film.

45. The method of claim 44, wherein the aluminum is disposed upon a substrate comprising titanium and silica.

46. An antireflective viewing surface comprising:
a viewing surface; and
a textured layer disposed upon the viewing surface; wherein the textured layer comprises a plurality of pores that are smaller than the wavelength of light.

47. The antireflective viewing surface of claim 46, wherein the pores are tapered having a depth to maximum diameter ratio of about 1 to about 10.

48. The antireflective viewing surface of claim 46, wherein the pores have an average depth of about 25 to about 1,000 nanometers and an average width of about 25 to about 300 nanometers.

49. The antireflective viewing surface of claim 46, wherein the pores have an aspect ratio of about 0.5 to about 5.

50. The antireflective viewing surface of claim 46, wherein the textured layer comprises a thermosetting resin, and wherein the thermosetting resin is obtained by the reaction of acrylates, methacrylates, epoxies, phenolics, polyurethanes, silicones, or a combination comprising at least one of the foregoing materials.
